(19) United States
(12) Patent Application Publication
(10) Pub. No.: US 2015/0180106 A1
(43) Pub. Date: Jun. 25, 2015

(54) BANDPASS MICROWAVE FILTER TUNABLE BY RELATIVE ROTATION OF AN INSERT SECTION AND OF A DIELECTRIC ELEMENT

(71) Applicants: THALES, NEUILLY-SUR-SEINE (FR); CENTRE NATIONAL DE LA RECHERCHE SCIENTIFIQUE, Paris (FR); CENTRE NATIONAL D'ETUDES SPATIALES, Paris (FR)

(72) Inventors: Hussein EZZEDDINE, TOURS (FR); Aurelien PERIGAUD, PANAZOL (FR); Olivier TANTOT, LIMOGES (FR); Nicolas DELHOTE, LIMOGES (FR); Stephane BILA, VERNEUIL/SUR/VIENNE (FR); Serge VERDEYME, AIXE/SUR/VIENNE (FR); Damien PACAUD, BEAUMONT/SUR/LEZE (FR); Laetitia ESTAGERIE, TOURNEFEUILLE (FR)

(21) Appl. No.: 14/574,255

(22) Filed: Dec. 17, 2014

(30) Foreign Application Priority Data
Dec. 20, 2013 (FR) 1303030

(51) Int. Cl. H01P 1/208; H01P 7/06; H01P 5/02

(52) U.S. Cl. CPC H01P 1/2084; H01P 5/02; H01P 7/06

(57) ABSTRACT

A bandpass filter for microwave-frequency wave which is frequency tunable, comprises at least one resonator. Each resonator comprises a cavity having a conducting wall substantially cylindrical in relation to an axis Z, and at least one dielectric element disposed inside the cavity. The resonator resonates on two perpendicular polarizations having respectively distributions of the electromagnetic field in the cavity that are deduced from one another by a rotation of 90° and according to one and the same frequency. The wall of the cavity comprises an insert section facing the element having a different shape from a section not situated facing the element. The insert section and the element are able to perform a rotation with respect to one another in relation to the axis Z so as to define at least a first and a second relative position differing by an angle substantially equal to 45° to within 20°.

### CROSS-REFERENCE TO RELATED APPLICATION

This application claims priority to foreign French patent application No. FR 1303030, filed on Dec. 20, 2013, the disclosure of which is incorporated by reference in its entirety.

### FIELD OF THE INVENTION

The present invention relates to the field of frequency-type filters in the microwave region, typically for frequencies lying between 1 GHz to 30 GHz. More particularly the present invention relates to frequency-tunable bandpass filters.

### BACKGROUND

The processing of a microwave-frequency wave, for example received by a satellite, requires the development of specific components, allowing propagation, amplification, and filtering of this wave.

For example a microwave-frequency wave received by a satellite must be amplified before being returned to the ground. This amplification is possible only by separating the set of frequencies received into channels, each corresponding to a given frequency band. Amplification is then carried out channel by channel. The separation of the channels requires the development of bandpass filters.

The development of satellites and the increased complexity of the signal processing to be performed, for example reconfiguration of the channels in flight, has led to the necessity to implement frequency-tunable bandpass filters, that is to say those for which it is possible to adjust the central filtering frequency customarily dubbed the filter tuning frequency.

One of the known technologies of bandpass filters tunable in the microwave region is the use of passive semi-conducting components, such as PIN diodes, continuously variable capacitors or capacitive switches. Another technology is the use of MEMS (for micro electromechanical systems) of ohmic or capacitive type.

These technologies are complex, greedy in terms of electrical energy and not very reliable. These solutions are also limited at the level of the signal power processed. Moreover a consequence of frequency tunability is an appreciable degradation in the performance of the filter, such as its quality factor Q. Finally, the RF losses (band achieved, “Return Loss”, insertion losses etc.) are degraded by the change of frequency.

Furthermore, the technology of filters based on dielectric elements is known. It makes it possible to produce non-tunable bandpass filters.

These filters typically comprise an at least partially closed cavity, comprising a conducting wall (typically metallic for example made of aluminium or invar) in which is disposed a dielectric element, typically of round or square shape (the dielectric material is typically zirconia, alumina or BMT).

An input excitation means introduces the wave into the cavity (for example a coaxial cable terminated by an electrical probe or a waveguide coupled by an iris) and an output excitation means of like nature makes it possible for the cavity to output the wave.

A bandpass filter allows the propagation of a wave over a certain frequency span and attenuates this wave for the other frequencies. A passband and a central frequency of the filter are thus defined. For frequencies around its central frequency, a bandpass filter has high transmission and low reflection.

The passband of the filter is characterized in various ways according to the nature of the filter.

The parameter S is a parameter which expresses the performance of the filter in terms of reflection and transmission. S11, or S22, corresponds to a measure of reflection and S12, or S21, to a measure of transmission.

A filter carries out a filtering function. This function can generally be approximated via mathematical models (Chebychev functions, Bessel functions, etc.). These functions are generally based on ratios of polynomials.

For a filter carrying out a filtering function of Chebychev or generalized Chebychev type, the passband of the filter is determined at equi-ripple of S11 (or S22), for example at 15 dB or 20 dB reduction in reflection with respect to its out-of-band level. For a filter carrying out a function of Bessel type, the band is taken at −3dB (when S21 crosses S11 if the filter has negligible losses).

A filter typically comprises at least one resonator comprising the metallic cavity and the dielectric element. A mode of resonance of the filter corresponds to a particular distribution of the electromagnetic field which is excited at a particular frequency.

In order to increase their selectivity, that is to say their capacity to attenuate the signal outside of the passband, these filters can be composed of a plurality of mutually coupled resonators.

The central frequency and the passband of the filter depend both on the geometry of the cavities and dielectric elements, as well as the mutual coupling of the resonators as well as couplings with the filter input and output excitation means. Coupling means are for example openings or slots dubbed irises, electrical or magnetic probes or microwave lines.

The filter allows through a signal whose frequency lies in the passband, but the signal is nonetheless attenuated by the filter losses.

The tuning of the filter making it possible to obtain a transmission maximum for a given frequency band is very tricky to carry out and depends on the whole set of parameters of the filter. It is moreover dependent on the temperature.

In order to perform an adjustment of the filter so as to obtain a precise central frequency of the filter, the resonant frequencies of the resonators of the filter can be very slightly modified with the aid of metallic screws, but this method performed in an empirical manner is very time consuming and allows only very little frequency tunability, typically of the order of a few %. In this case, the objective is not tunability but the obtaining of a precise value of the central frequency, and it is desired to obtain reduced sensitivity of the frequency of each resonator in relation to the depth of the screw.

The circular or square symmetry of the resonators simplifies the design of the filter.

Depending on its geometry, generally a resonator has one or more resonant modes each characterized by a particular (distinctive) distribution of the electromagnetic field giving rise to a resonance of the microwave-frequency wave in the structure at a particular frequency. For example, TE (for Transverse Electric or H as it is called) or TM (for Transverse Magnetic or E as it is called) modes of resonance having a certain numbers of energy maxima labelled by indices, may be excited in the resonator at various frequencies. FIG. 1 describes by way of example the resonant frequencies of the various modes for an empty circular cavity as a function of the dimensions of the cavity (diameter D and height H).

To optimize the compactness of the filters, resonator filters operating on several modes (typically 2 or 3) are known in the art. In particular, filters operating according to a dual mode (“dual mode filter” as it is called) are known. These modes have two perpendicular polarizations X and Y having a distinctive and specific distribution of the electromagnetic field in the cavity: the distributions of the electromagnetic fields corresponding to the two polarizations are orthogonal and are deduced from one another by a rotation of 90° about an axis of symmetry of the resonator.

If the symmetry of the resonator is perfect, the two orthogonal polarizations possess the same resonant frequency and are not coupled. The coupling between polarizations is obtained by breaking the symmetry, for example by introducing a discontinuity (perturbation) at 45° of the polarization axes X and Y, typically with the aid of metallic screws.

Moreover, the resonant frequencies can be tuned (optionally to different frequencies) by introducing discontinuities (perturbations) into the polarization axes (X and Y).

Thus the two polarizations X and Y of a dual mode can resonate according to one and the same frequency (symmetry in relation to the polarization axes) or according to two slightly different frequencies (dissymmetry in relation to the polarization axes).

The dual modes thus make it possible to achieve two electrical resonances in a single resonant element. Several modes possessing these particular field distributions can be used. For example the dual modes TE11n (H11n) are much used in cavity filters since they culminate in a good compromise between a high quality factor (all the more the larger the index n), reduced bulkiness (halved by employing dual modes) and significant frequency isolation with respect to the other resonant modes (that it is not desired to couple in order to ensure the proper operation of the filter).

### SUMMARY OF THE INVENTION

The aim of the present invention is to produce filters of cavity type with dielectric elements, which are compact, tunable in terms of central frequency, and do not have the aforementioned drawbacks (quality factor and RF losses degraded through tunability, poor power withstand etc.).

For this purpose the subject of the invention is a bandpass filter for microwave-frequency wave, frequency tunable, comprising at least one resonator,
each resonator comprising a cavity having a conducting wall substantially cylindrical in relation to an axis Z, and at least one dielectric element disposed inside the cavity,
the resonator resonating on two perpendicular polarizations having respectively distributions of the electromagnetic field in the cavity that are deduced from one another by a rotation of 90°,
the wall of the cavity comprising an insert section facing the element having a different shape from a section not situated facing the element,
the insert section and the element being able to perform a rotation with respect to one another in relation to the axis Z so as to define at least a first and a second relative position differing by an angle substantially equal to 45° to within 20°.

According to one embodiment, at least one shape from among the shape of the insert section and the shape of the element comprises at least two orthogonal symmetry planes cutting one another along the axis Z.

Advantageously, the shape of the insert section and the shape of the element each comprise at least two orthogonal symmetry planes S1, S3, Si1, Si3 cutting one another along the axis Z.

Advantageously, the first position is such that the symmetry planes of the insert section coincide with the symmetry planes of the element to within 10°.

According to one embodiment at least one shape from among the shape of the insert section and the shape of the element has four symmetry planes S1, S2, S3, S4, Si1, Si2, Si3, Si4, two consecutive symmetry planes being separated by an angle of 45°, and cutting one another along the axis Z.

Advantageously, at least one shape from among the shape of the insert section and the shape of the element has concavities and/or convexities whose extrema are situated in the vicinity of axes of symmetry.

Preferably, the substantially cylindrical shape has a director curve chosen from among a circle, a square.

Preferably, a mode of resonance of the resonator is of the type H113 having three maxima of the electric field in the said cavity along the axis Z.

As a variant, the resonator furthermore comprises means of rotation able to carry out the said rotation.

According to one embodiment, the insert section is movable with respect to the conducting wall.

Preferably, the movable insert section comprises a movable adjusting ring.

According to one embodiment the dielectric element is movable with respect to the conducting wall.

Advantageously, the means of rotation comprise a rod rigidly attached to the dielectric element and comprising a dielectric material.

According to one embodiment, the filter comprises a plurality of resonators and coupling means adapted for coupling together two consecutive resonators.

Preferably, the filter furthermore comprises linking means adapted for equalizing the respective rotations of the means of rotation of the resonators.

Advantageously, the linking means comprise the said rod rigidly attached to a plurality of elements disposed along the rod.

According to another aspect, the invention relates to a microwave circuit comprising at least one filter according to the invention.

### BRIEF DESCRIPTION OF THE DRAWINGS

Other characteristics, aims and advantages of the present invention will become apparent on reading the detailed description which will follow and with regard to the appended drawings given by way of nonlimiting examples and in which:

FIG. 1 illustrates the modes of resonance of an empty circular cavity.

FIGS. 2a-2b describe a filter according to a variant of the invention according to a cross-section.

FIGS. 3a-3b describe a filter according to another variant of the invention according to a cross-section.

FIGS. 4a-4b describe a filter according to a preferred variant of the invention comprising at least four orthogonal symmetry planes. FIG. 4a describes the resonator of the filter according to a first position P1 and FIG. 4b describes the resonator of the filter according to a second relative position P2.

FIGS. 5a-5b describe the filter of FIGS. 4a-4b viewed in perspective.

FIG. 5a describes the resonator of the filter according to a first position P1 and FIG. 5b describes the resonator of the filter according to a second relative position P2.

FIGS. 6a-6b illustrate a variant of shape of insert section and of element according to the invention (6a position P1, 6b position P2)

FIGS. 7a-7b illustrate another variant of shape of insert section and of element according to the invention (7a position P1, 7b position P2)

FIGS. 8a-8b illustrate another variant of shape of insert section and of element according to the invention (8a position P1, 8b position P2)

FIGS. 9a-9b illustrate the variations of the electric field of a polarization resonating in the cavity of the resonator of the filter according to the invention.

FIGS. 10a-10b illustrate a filter comprising two resonators each comprising a cavity and a dielectric element, the resonators being coupled together with the aid of a coupling means (FIG. 10a position P1, FIG. 10b position P2).

FIG. 11 illustrates a filter according to the invention having input and output means producing a lateral coupling.

FIG. 12 illustrates a filter comprising three resonators (OK?).

FIGS. 13a-13b illustrate the frequency behaviour of the filter of FIG. 10.

FIGS. 14a-14b describe a second variant of the invention according to which the element is movable with respect to the conducting wall.

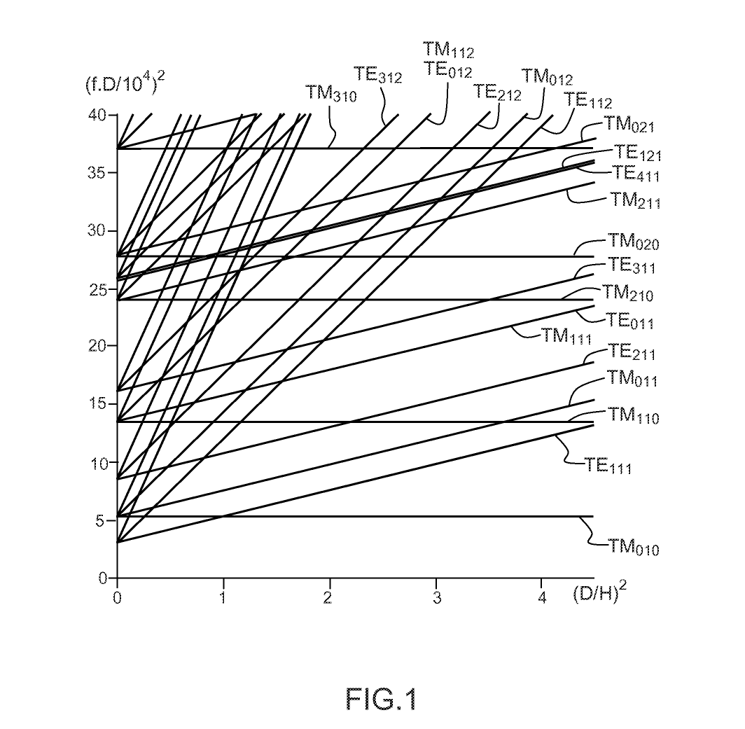

### DETAILED DESCRIPTION

The invention consists in producing a bandpass filter tunable in terms of central frequency of “dual mode” type on the basis of a rotation of various elements making up the filter. The filter comprises at least one resonator R, each resonator comprising a cavity 30 having a, typically metallic, conducting wall substantially cylindrical in relation to an axis Z, and at least one dielectric element disposed inside the cavity,

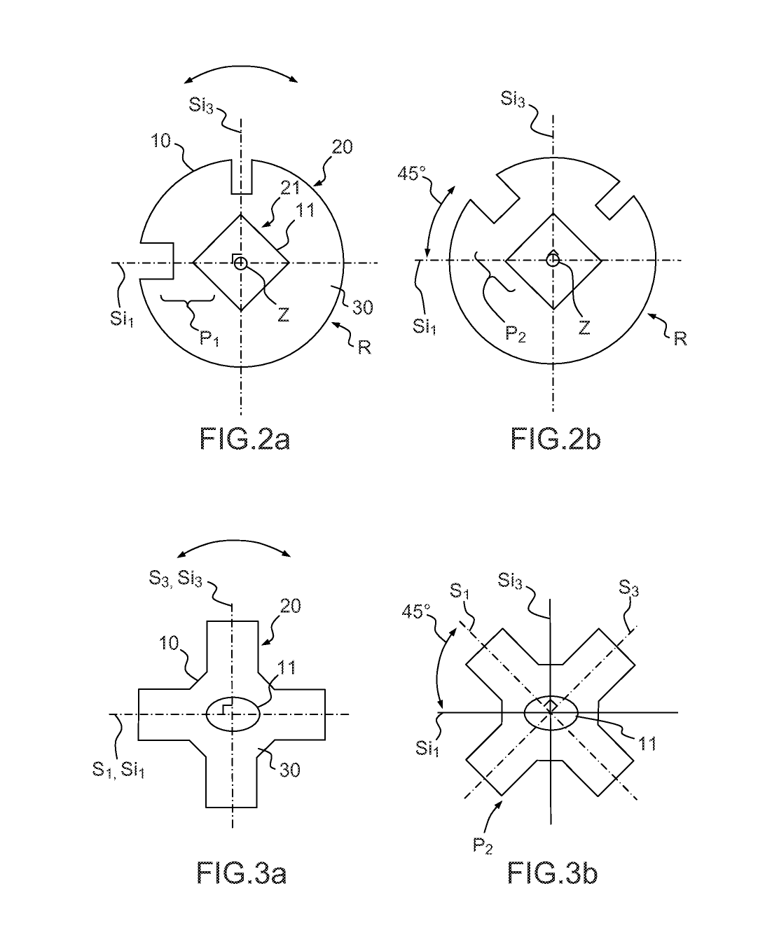

FIG. 2 describes a cross-section through a resonator R of the filter according to the invention in a plane perpendicular to the axis Z.

The filter operates on a dual mode (“dual mode filter”), thereby signifying that the resonator resonates on two perpendicular polarizations dubbed X and Y which respectively have distributions of the electromagnetic field in the cavity 30 that are deduced from one another by a rotation of 90°.

The two polarizations can resonate at the same frequency or at slightly different frequencies. In the latter case the frequency response of the filter is dissymmetric.

Moreover, the symmetry of the mode can be slightly broken so as to couple the two polarizations (see further on).

In the cavity 30 is disposed at least one dielectric element 21.

The wall of the cavity is globally cylindrical but comprises a specific section, dubbed the insert section 20, situated facing the element 21, that is to say corresponding to the part of the wall substantially “opposite” the element in the cavity 30. The insert section 20 has a shape 10 different from the shape of a section of this same wall not situated facing the element. Preferably, it is the shape of the interior wall of the cavity which has a specific shape.

For example in FIGS. 2a and 2b, the wall of the cavity has a cylindrical shape of revolution, but the shape of the insert section 10 differs from a circle.

The insert section 20 and the element 21 are able to perform a rotation with respect to one another in relation to the axis Z so as to define at least a first relative position P1 and a second relative position P2 differing by an angle substantially equal to 45° to within 20°. FIG. 2a describes the resonator according to the first position P1 and FIG. 2b describes the resonator according to the second relative position P2. The relative angle between the element and the insert section varies by around 45°+/−20° between the two positions. Thus the relative angle lies between 25° and 65°. Preferably, the relative angle lies between 45°+/−10°, i.e. lies between 35° and 55°.

The contours of the insert section and the element are adapted so that the first position P1 corresponds to a geometry of resonator resonating according to a first central frequency f1, and the second position P2 corresponds to a geometry of resonator resonating according to a second central frequency f2. Thus the relative rotation of the element with respect to the insert section makes it possible to modify the central frequency of the filter according to the invention, according to at least two values f1 and f2 of central frequency, this being adapted for applications of “channel jump” type. Such an effect is obtained by variation of the capacitive effect induced by the rotation, as described further on.

A filter according to the invention thus has numerous advantages. The filter is both dual, with all the associated advantages such as compactness, and tunable. The RF performance is not substantially degraded by the change of frequency, and neither is the quality factor Q substantially degraded compared with those conventionally obtained with resonant cavities, inter alia on account of the limited impact of the dielectric element 21 on the losses of the filter. Typically a Q factor >10000 is obtained for a filter according to the invention, whereas the other known tuning solutions, either are not applicable to the production of a dual-mode filter, or greatly degrade the losses with respect to a filter with no tuning element.

Furthermore, it has a narrow band (see further on an example of performance as a function of frequency). Moreover, the filter is capable of supporting a microwave signal of high power, typically greater than 150 W.

These power withstand levels are totally inconceivable with semi-conducting components or MEMS.

According to one embodiment, when a single of the two shapes has two orthogonal symmetry planes, the shape having these planes is fixed.

Preferably, the resonator of the filter according to the invention furthermore comprises means of rotation able to produce the rotation.

Preferably, a filter according to the invention has an insert section or an element having properties of particular symmetry allowing the filter to fulfill in an optimal manner the desired function.

Thus at least one shape from among the shape 10 of the insert section 20 and the shape 11 of the element 21 comprises at least two orthogonal symmetry planes cutting one another along the axis Z.

In FIG. 2 by way of example it is the shape 11 of the element 21, that is to say the exterior contour of the element according to a section perpendicular to the axis Z, which comprises at least two orthogonal symmetry planes Si1 and Si3, cutting one another along the axis Z, shown diagrammatically according to two solid straight lines in the cross-sectional diagrams of FIGS. 2a and 2b. The angle of rotation can be referenced for example with respect to the axes S1 and Si1, but it is the relative angle between the element and the insert section which varies by around 45°+/−20° between the two positions.

FIG. 3 (FIGS. 3a and 3b) illustrates another variant of geometry of the shape 10 of the insert section 20 and of the shape 11 of the element 21. FIG. 3a describes the resonator according to the first position P1 and FIG. 3b describes the resonator according to the second relative position P2.

In FIG. 3 the shape 10 of the insert section 20, that is to say the perimeter of the wall according to a section facing the element (preferably the interior perimeter) comprises at least two orthogonal symmetry planes S1 and S3 cutting one another along the axis Z, shown diagrammatically according to two dotted straight lines in the cross-sectional diagrams of FIGS. 3a and 3b. By shape of the insert section 10 is intended to mean the overall shape, disregarding the elements for fine adjustment, such as screws at 45° (not represented), locally introducing a slight dissymmetry so as to mutually couple the two polarizations.

In this example the shape 21 of the element 11 also has two symmetry planes Si1 and Si3. Thus according to this variant the shape 10 of the insert section 20 and the shape 11 of the element 21 each comprise at least two orthogonal symmetry planes, respectively (S1, S3) and (Si1, Si3), cutting one another along the axis Z.

According to a preferred variant, for easier optimization of the various elements of the filter, the first position P1 is such that the symmetry planes S1 and S3 of the insert section 20 coincide with the symmetry planes Si1 Si3 of the element 21 to within 10°, as is illustrated in FIG. 3.

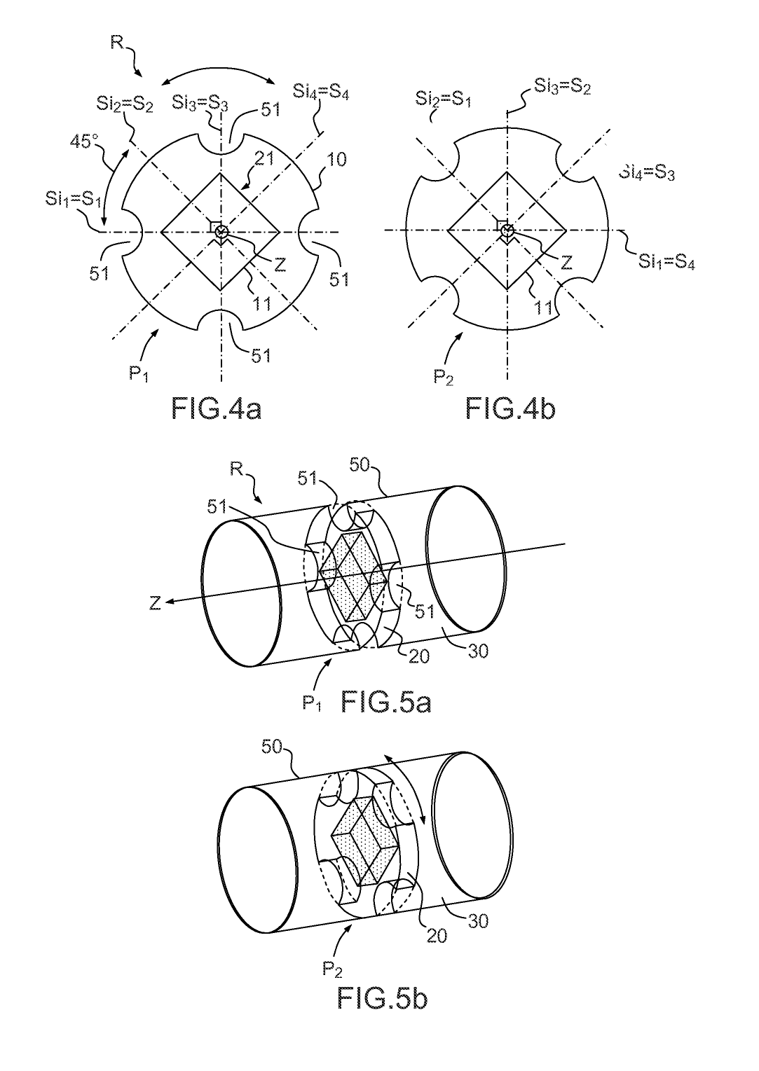

According to a preferred variant, illustrated in FIGS. 4 and 5, the shape 10 of the insert section 20 and/or the shape 11 of the element 21 has four symmetry planes dubbed S1, S2, S3 and S4 for the insert section and Si1, Si2, Si3 and Si4 for the element, two consecutive symmetry planes being separated by an angle of 45°, and cutting one another along the axis Z. This geometry also allows a calculation for optimizing the dual-mode filter that is simpler and faster, with a simplified design of the structure of the filter.

As illustrated in FIG. 4, for the variant according to which for the position P1 the planes of symmetry coincide, during a rotation of 45° for the position P2, there is always coincidence since the consecutive planes are separated by an angle of 45°.

For example according to P1:

S1=Si1; S2=Si2; S3=Si3; S4=Si4.

According to P2, for a rotation of 45° of the insert section, i.e. planes S1 to S4.

S1=Si2; S2=Si3; S3=Si4; S4=Si1.

FIG. 4 is a sectional view perpendicularly to the axis Z, and FIG. 5 a perspective view, making it possible to depict the insert section 20. FIGS. 4a and 5a describe the resonator R according to the first position P1 and FIGS. 4a and 4b describe the resonator R according to the second relative position P2.

FIGS. 4 and 5 also illustrate a first variant in which it is the insert section 20 which is movable with respect to the element 21. Preferably the insert section is also movable with respect to the conducting wall 50 of the resonator R, so as to preserve the continuity of the wall 50. An insert section that is movable in rotation is then disposed inside the cavity 30. The shape of the insert section is obtained by adding metallic parts 51 (which are for example convexities when considering these surfaces from the interior of the cavity), along the section, these parts locally modifying, here locally decreasing, in the regions facing the element, the diameter of the cavity and therefore the distance between the element and the metallic wall 50. For example the insert section corresponds to an adjusting ring rendered movable. According to the azimuthal angle, the radius of the ring is variable so the perturbation seen by the 2 polarizations X and Y is different in the positions P1 and P2 (see hereinbelow).

For example the adjusting ring is rendered movable with the aid of a revolving seal rotating so as to maintain electrical continuity between the fixed part and the movable part.

In FIG. 5 in perspective, the structure of the element and of the insert section in the direction Z is homogeneous. This homogeneity corresponds to a preferred, because simpler to achieve, embodiment, but the Z-wise structure could also be variable.

A cylindrical surface is defined by a director curve described by a straight line dubbed the generator of the cylinder. The director curve of the wall of the filter according to the invention is preferably a circle or a square, for reasons of intrinsic symmetry of this type of cavity and of ease of design and manufacture.

A dual mode is preferably established according to certain particular modes of cavity, corresponding therefore to preferred embodiments of the invention. An example is the mode of type TE11n (or H11n as it is referred to), n corresponding to the number of variations of the electric field (minima or maxima) along the axis Z of the cavity. According to a preferred embodiment, n=3, this case corresponding to a compromise between bulkiness and electrical performance (losses and frequency isolation).

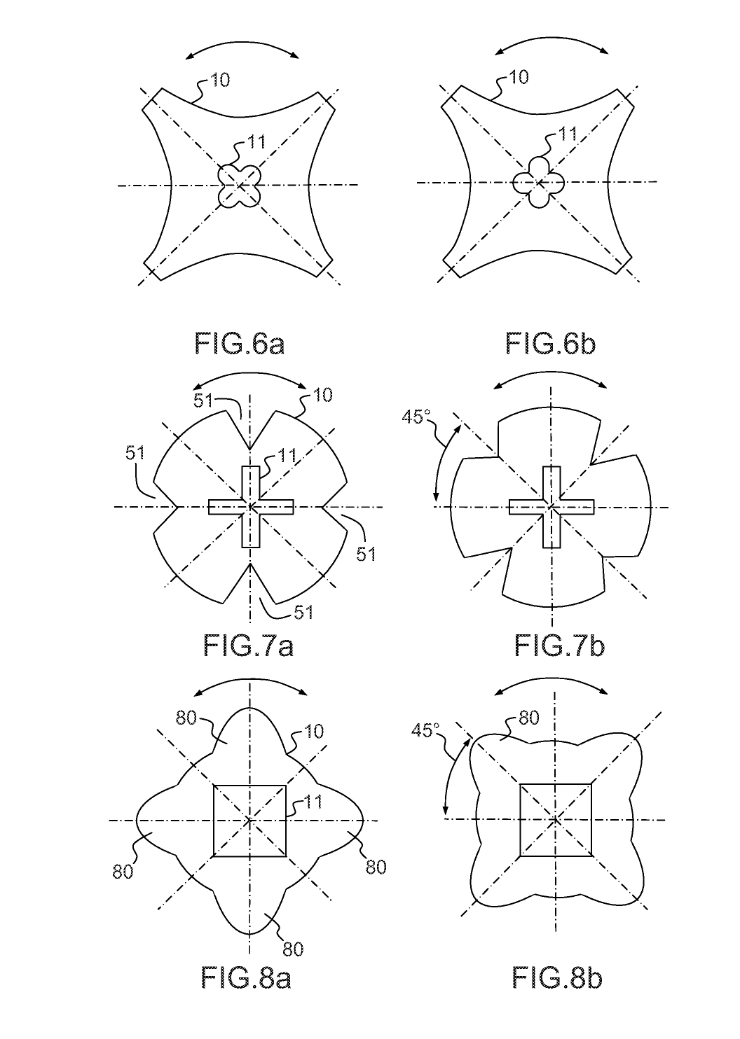

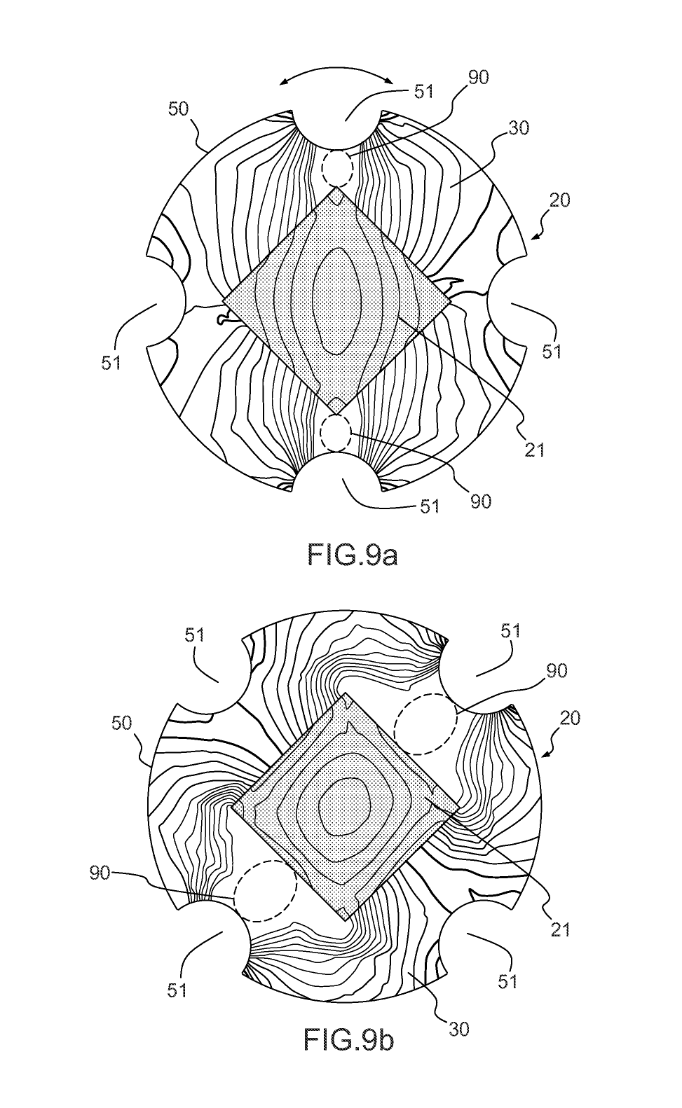

FIGS. 6, 7 and 8 illustrate variants of shapes of insert section 10 and of element 11 and of relative rotation of one with respect to the other of a resonator according to the invention. In FIG. 8 concavities 80 (viewed from the interior of the cavity) locally increase the distance between the element and the metallic wall.

To comply with the symmetry conditions while obtaining a variation of the capacitive effect, according to one embodiment the shape of the insert section and/or the shape of the element has concavities and/or convexities whose extrema are situated in the vicinity of axes of symmetry of the resonator.

For the insert section: in the vicinity of the symmetry planes (S1, S2, S3, S4). For the element: in the vicinity of the symmetry planes (Si1, Si2, Si3, Si4).

This embodiment is of course compatible with a system comprising only two symmetry planes, as illustrated in FIGS. 2 and 3.

Furthermore, it is of course not necessary for concavity/convexity to exist in the vicinity of each axis of symmetry, the constraint being to comply with the symmetry condition.

FIG. 9 illustrates the variations of the electric field of one of the polarizations (X or Y) resonating in the cavity of the resonator of FIGS. 4-5. FIG. 9a describes the resonator R according to the first relative position P1 and FIG. 9b describes the resonator R according to the second relative position P2, for which the insert section 20 has performed a rotation of 45° with respect to the element 21. The dashed zones referenced 90 illustrate the zones for which the electric field has a maximum.

For the first position P1, the electric field is concentrated between the tips of the element and the convexities/protuberances 51 of the insert section.

For the second position P2 this electric field is concentrated between the edges of the element and the convexities 51.

Modification of the resonant frequency of the filter is obtained by variation of the capacitive effect between the insert 21 and the insert section 20. Indeed it is possible to model the frequency behaviour of a resonator by an equivalent electrical circuit: a resistance-capacitance-inductance parallel association (RLC resonator). This circuit possesses a resonant frequency dependent on the product L.C. When the capacitive effect is altered, the value of the capacitance varies, giving rise to a variation of the resonant frequency.

The capacitive effect induced by the presence of a dielectric element is dependent on its geometry and on the characteristics of the material of which it is composed (dielectric permittivity), and also on the mode of resonance (in particular on the associated distribution of the electromagnetic field). As a function of the mode (or of the polarization for a dual mode), the electromagnetic field is influenced by only a part of the element. A variation of the shape of the element in zones of large amplitude of the electric field modifies the capacitive effect of the resonator. The contrast obtained in the capacitive effect is maximized when this variation is located on an electric field maximum. In the case of a dual-mode filter, the effect must be globally the same on each polarization to obtain the same frequency shift for both polarizations.

As a variant, the filter comprises a plurality of resonators and coupling means adapted for coupling together two consecutive resonators.

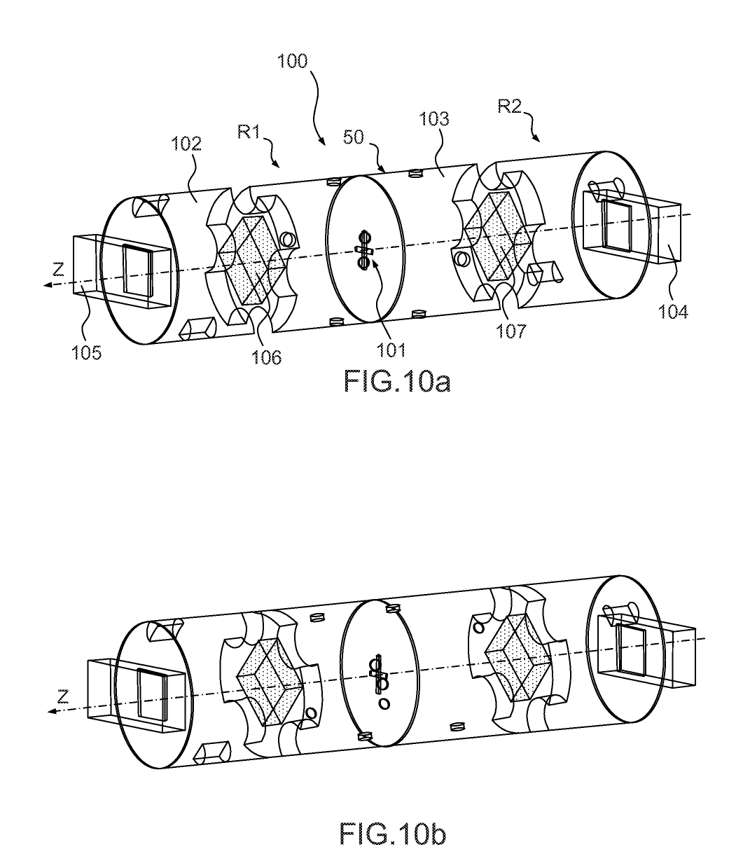

FIG. 10 (FIG. 10a position P1, FIG. 10b position P2) illustrates a filter 100 comprising two resonators R1 and R2 each comprising a cavity 102 and 103, and a dielectric element 106, 107, the resonators being coupled together with the aid of a coupling means 101, here an iris. Means respectively of input 104 and of output 105 allow the microwave-frequency wave respectively to enter and to exit the filter.

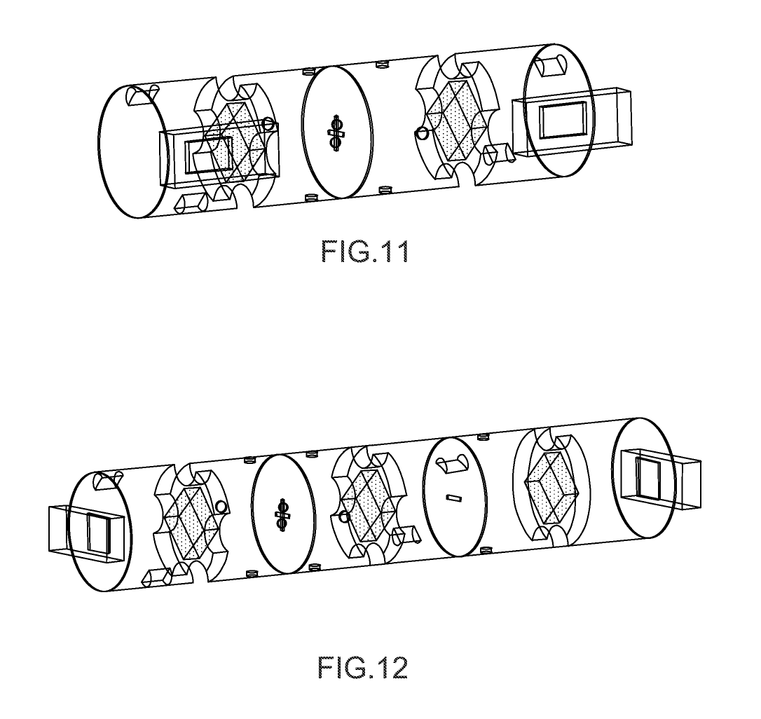

The cylindrical metallic wall 50 is in this example common to the two cavities, and the coupling is carried out through the bottom. But the filter according to the invention is of course compatible with a lateral coupling, as illustrated in FIG. 11.

The filter 100 of FIG. 10 comprises two cavities, each resonating on two polarizations, and thus constitutes a so-called “4-pole” filter.

The invention is of course compatible with 3 (or more) cavities, making it possible to obtain a narrower passband, such as illustrated in FIG. 12.

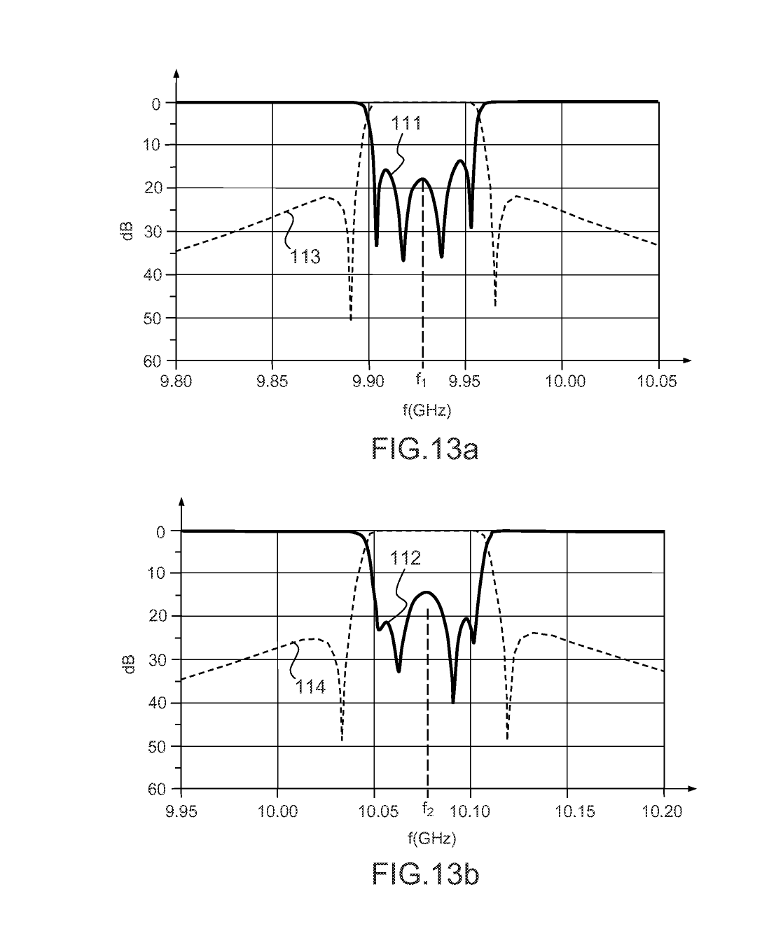

An example of frequency behaviour of the filter of FIG. 10 is illustrated in FIG. 13 (FIG. 13a position P1, FIG. 13b position P2). The dual mode is of type H113 and the parameters of the filter of this example are:

Total length: 90 mm; diameter of the cylinder 27 mm; use of a movable adjusting ring; dielectric element made of alumina (permittivity 9.4) of square shape with side 12 mm×12 mm and of Z-wise thickness 4 mm. The curves 111 and 112 (solid line) corresponds to the curves of type S11 (reflection of the filter) and the curves 113 and 114 (dashed line) to the curves of type S21 (transmission of the filter). Between the two positions P1 and P2 a variation of about 150 MHz, (1.5%) of the resonant frequency, is noted.

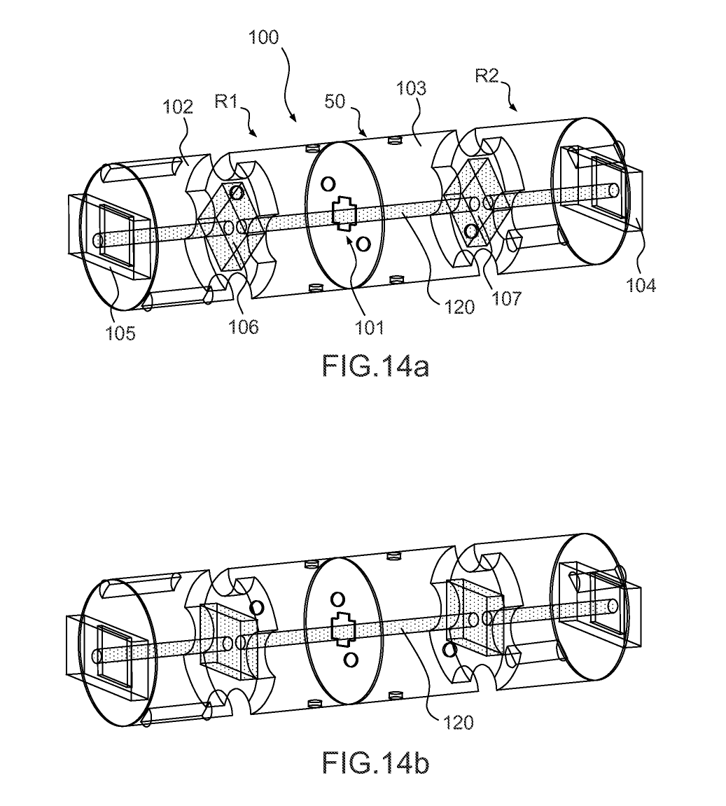

According to a second variant of the invention illustrated in FIG. 14 (FIG. 14a position P1, FIG. 14b position P2) the element is movable with respect to the conducting wall and with respect to the insert section which is fixed. In this example the means of rotation comprise a rod 120 of dielectric material rigidly attached to the element, or to a plurality of element when the structure of the cavities so allows, such as in FIG. 12. Indeed in FIG. 12 the coupling is carried out through the bottom, the successive elements are thus aligned along one and the same axis and can therefore all be rigidly attached to one and the same rod. This geometry has the advantage of allowing the control of the whole set of rotations of the plurality of element with one and the same element. This geometry is of course compatible with a lateral coupling, rather than through the bottom as illustrated in FIG. 14.

In one embodiment the filter furthermore comprises linking means adapted for equalizing the respective rotations of the means of rotation of the resonators.

For the second variant in which the elements are movable and rigidly attached to one and the same rod 120, the rod is also a linking means. The means of rotation can also comprise a stepper motor to control the rotation of the elements, in the case where a reconfiguration of the filter must be performed in flight for example.

According to another aspect the subject of the invention is also a microwave circuit comprising at least one filter according to the invention.

1. A bandpass filter for microwave-frequency wave, frequency tunable, comprising at least one resonator,
each resonator comprising a cavity having a conducting wall substantially cylindrical in relation to an axis Z, and at least one dielectric element disposed inside the cavity,
said resonator resonating on two perpendicular polarizations having respectively distributions of the electromagnetic field in the cavity that are deduced from one another by a rotation of 90°,
the wall of the cavity comprising an insert section facing said element having a different shape from a section not situated facing the element,
the insert section and the element being able to perform a rotation with respect to one another in relation to the axis Z so as to define at least a first and a second relative position differing by an angle substantially equal to 45° to within 20°.

2. The filter according to claim 1, in which at least one shape from among the shape of the insert section and the shape of the element comprises at least two orthogonal symmetry planes cutting one another along the axis Z.

3. The filter according to claim 1, in which the shape of the insert section and the shape of the element each comprise at least two orthogonal symmetry planes cutting one another along the axis Z.

4. The filter according to claim 3, in which the first position is such that said symmetry planes of the insert section coincide with said symmetry planes of the element to within 10°.

5. The filter according to claim 1, in which at least one shape from among the shape of the insert section and the shape of the element has four symmetry planes, two consecutive symmetry planes being separated by an angle of 45°, and cutting one another along the axis Z.

6. The filter according to claim 2, in which at least one shape from among the shape of the insert section and the shape of the element has concavities and/or convexities whose extrema are situated in the vicinity of axes of symmetry.

7. The filter according to claim 1, in which the substantially cylindrical shape has a director curve chosen from among a circle, a square.

8. The filter according to claim 1, in which a mode of resonance of the resonator is of the type H113 having three maxima of the electric field in said cavity along the axis Z.

9. The filter according to claim 1, in which the resonator further comprises means of rotation able to carry out said rotation.

10. The filter according to claim 1, in which the insert section is movable with respect to the conducting wall.

11. The filter according to claim 10, in which the movable insert section comprises a movable adjusting ring.

12. The filter according to claim 1, in which the dielectric element is movable with respect to the conducting wall.

13. The filter according to claim 9, in which said means of rotation comprise a rod rigidly attached to the dielectric element and comprising a dielectric material.

14. The filter according to claim 1, comprising a plurality of resonators and coupling means adapted for coupling together two consecutive resonators.

15. The filter according to claim 14, further comprising linking means adapted for equalizing the respective rotations of the means of rotation of the resonators.

16. The filter according to claim 15, in which the linking means comprise said rod rigidly attached to a plurality of elements disposed along the rod.

17. A microwave circuit comprising at least one filter according to claim 1.
